(19) United States
(12) Patent Application Publication
(10) Pub. No.: US 2024/0271702 A1
(43) Pub. Date: Aug. 15, 2024

(54) In-situ gasket formation

(71) Applicant: Applied Materials, Inc., Santa Clara, CA (US)

(72) Inventors: Yao-Hung YANG, Santa Clara, CA (US); Chih-Yang CHANG, Santa Clara, CA (US); Shannon WANG, Santa Clara, CA (US)

(21) Appl. No.: 18/108,427

(22) Filed: Feb. 10, 2023

(51) Int. Cl. F16J 15/328

(52) U.S. Cl. CPC F16J 15/328

(57) ABSTRACT

A method for forming an elastomer gasket in-situ on a part used for substrate processing that is tunable to a cross-section and/or length of a sealing surface such as a gasket groove or planar sealing surface. The method may include forming, in-situ, a first layer of at least one type of gasket material directly onto a bottom of the sealing surface of the part, forming subsequent layers of the at least one type of gasket material on at least one previously formed layer, and adjusting a number of subsequent layers of the at least one type of gasket material based on dimensions of the sealing surface.

### FIELD

Embodiments of the present principles generally relate to semiconductor processing of semiconductor substrates.

### BACKGROUND

Gaskets are used to seal apparatus from external environments or to prevent gases from escaping during in semiconductor substrate processing. In some cases, the gaskets can be inserted into grooves or placed on flat surfaces to provide a seal for two mating surfaces. Smaller gasket sizes are typically easy to manipulate into position. However, the inventors have observed that larger gaskets tend to be stretched out of shape when positioning into place. Changes in the gasket shape can lead to poor sealing between the mating surfaces. The inventors also observed that when a person is involved in the manual installation of the gasket, the amount of deformation can vary depending on the particular person doing the installation. The inconsistencies lead to further gasket and part failures.

Accordingly, the inventors have provided a method for providing in-situ gasket formation for parts used in substrate processing, increasing gasket installation uniformity and sealing performance.

### SUMMARY

Methods for in-situ gasket formation for parts used in substrate processing are provided herein.

In some embodiments, a method of creating a gasket may comprise obtaining a part used for substrate processing, the part having a sealing surface for interfacing with an elastomer gasket and forming the elastomer gasket layer-by-layer on the sealing surface.

In some embodiments, the method may further include cleaning the part prior to forming the elastomer gasket on the sealing surface and adjusting a dimension of the elastomer gasket to compensate for changes to the sealing surface caused by cleaning the part, adjusting the dimension of the elastomer gasket based on a number of cleaning cycles undergone by the part, where the sealing surface is a gasket groove or a planar surface, where the gasket groove has a bottom width and an opening width of approximately similar dimensions or a bottom width of greater dimensions than an opening width, forming the elastomer gasket with a cross-section profile of a star, a circle, a rectangle, a circle, a polygon, or a triangle, forming the elastomer gasket using multiple types of gasket materials, where the multiple types of gasket materials have different Shore hardness scale values, forming a core of the elastomer gasket of a metallic material and outer portions of the elastomer gasket of a non-metallic material, heating the elastomer gasket after formation of the elastomer gasket is completed, forming the elastomer gasket using a thermoplastic polyurethane material, a thermoplastic elastomer material, or a thermoplastic copolyester material, forming the elastomer gasket using a contact printer with an angled printing nozzle of less than 90 degrees, forming the elastomer gasket using two or more gasket materials deposited using a contact printer with two or more printing nozzles for simultaneous deposition of the two or more gasket materials, forming the elastomer gasket using a contact printer and tilting a base of the contact printer during formation of the elastomer gasket in a recessed area of a gasket groove in the part, and/or adjusting at least one cross-sectional dimension over a length of the elastomer gasket to compensate for dimensional changes of the sealing surface.

In some embodiments, a method of creating an elastomer gasket may comprise obtaining a part used for substrate processing, the part having a gasket groove for interfacing with an elastomer gasket, cleaning the part, adjusting a dimension of the elastomer gasket to compensate for changes to the gasket groove caused by cleaning the part, and forming the elastomer gasket layer-by-layer in the gasket groove.

In some embodiments, the method may further include adjusting the dimension of the elastomer gasket based on a number of cleaning cycles undergone by the part, forming the elastomer gasket using multiple types of gasket materials, and/or adjusting at least one cross-sectional dimension over a length of the elastomer gasket to compensate for dimensional changes of the gasket groove.

In some embodiments, a non-transitory, computer readable medium having instructions stored thereon that, when executed, cause a method for creating a gasket to be performed, the method may comprise obtaining a part used for substrate processing, the part having a sealing surface for interfacing with an elastomer gasket and forming the elastomer gasket layer-by-layer on the sealing surface.

In some embodiments, the method of the non-transitory, computer readable medium may further include where the sealing surface is a gasket groove with a bottom width of greater dimensions than an opening width, forming the elastomer gasket with a cross-section profile of a star, a circle, a square, a circle, or a triangle, forming the elastomer gasket using multiple types of gasket materials and the multiple types of gasket materials have different Shore hardness scale values, forming a core of the elastomer gasket of a metallic material and outer portions of the elastomer gasket of a non-metallic material, adjusting a size of the elastomer gasket formed based on a number of cleaning cycles undergone by the part, and/or adjusting at least one cross-section dimension over a length of the elastomer gasket to compensate for dimensional changes of the sealing surface.

Other and further embodiments are disclosed below.

### BRIEF DESCRIPTION OF THE DRAWINGS

Embodiments of the present principles, briefly summarized above and discussed in greater detail below, can be understood by reference to the illustrative embodiments of the principles depicted in the appended drawings. However, the appended drawings illustrate only typical embodiments of the principles and are thus not to be considered limiting of scope, for the principles may admit to other equally effective embodiments.

FIG. 1 depicts a cross-sectional view of a process chamber in accordance with some embodiments of the present principles.

FIG. 2 depicts a cross-sectional view of a cooling apparatus with a spiral gasket groove in accordance with some embodiments of the present principles.

FIG. 3 depicts a side view and cross-sectional views of manual gasket installations in accordance with some embodiments of the present principles.

FIG. 4 depicts cross-sectional views of a cooling apparatus undergoing recycling processes in accordance with some embodiments of the present principles.

FIG. 5 is a method of forming an in-situ gasket on a part used for substrate processing in accordance with some embodiments of the present principles.

FIG. 6 depicts an isometric view of a contact printer in accordance with some embodiments of the present principles.

FIG. 7 depicts cross-sectional views of a contact printer printing an in-situ gasket in accordance with some embodiments of the present principles.

FIG. 8 depicts cross-sectional views of gasket profiles in accordance with some embodiments of the present principles.

FIG. 9 depicts a cross-sectional view of a gasket groove in accordance with some embodiments of the present principles.

FIG. 10 depicts cross-sectional views of a contact printer printing undercut gasket grooves in accordance with some embodiments of the present principles.

FIG. 11 depicts a top-down view and a cross-sectional view of a valve slit door having an in-situ gasket formed on a planar sealing surface in accordance with some embodiments of the present principles.

FIG. 12 depicts cross-sectional views of in-situ gasket formation using multiple types of gasket materials in accordance with some embodiments of the present principles.

FIG. 13 depicts a cross-sectional view and a top-down view of linear gasket formation in a spiral gasket groove in accordance with some embodiments of the present principles.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

The methods provide processes for in-situ formation of gaskets for parts used for substrate processing. The in-situ formation process eliminates gasket stretching variations caused by manual installation of gaskets, dramatically increasing the sealing integrity and performance of the gaskets. In some embodiments, the direct three-dimensional (3D) printing of gaskets allows a variety of gasket shapes to be formed in a variety of groove shapes based on the sealing requirements of the part. The methods also enable the ability to have unlimited recycle cleaning of a part because the gasket size can be customized to adapt to an after-cleaning groove size increase. In some embodiments, the gasket size can be adjusted for each cycle of cleaning (number of cycles) to compensate for the increasing groove sizes due to the cleaning process. Adjusting of the gasket size to accurately account for a gasket groove decreases the inconsistencies between gasket groove sizes and advantageously prevents crosstalk and/or leakage of the gasket.

Manual gasket installation introduces unwanted gasket stretches that are evident through the varying lengths of gasket left after each installation. Each individual installer may pull more or less on the gasket during installation leaving the gasket deformed and various amounts of gasket “remnants” after installation. The deformation reduces the quality of the seal provided by the gasket. For example, the inventors have observed crosstalk leak issues between spiral channels between a showerhead of a process chamber and a cooling assembly used to cool the showerhead in the process chamber. The poor sealing of the spiral gasket leads to temperature variations and thermal damage. The inventors have also observed that after the apparatus is cleaned or recycled using an etching process, the size of the gasket grooves increased, leading to further sealing issues and ultimately limiting the number of cleaning cycles that an apparatus can undergo (reducing the working lifetime of the apparatus). The methods of the present principles solve the issues and also allow formation of different shapes of gaskets (e.g., round, rectangular, spiral, etc.) that can be adjusted to a given surface, groove, or length. The gaskets can also be formed in-situ, not only in gasket grooves, but also on flat sealing surfaces such as sealing surfaces of a slit valve door and the like.

As used herein, the term “gasket” includes gaskets formed in a closed loop or gaskets formed in an open loop. A closed loop gasket may have any loop shape such as, for example but not meant to be limiting, a round or o-ring loop shape, a rectangular loop shape, or a loop shape that mimics a part shape and the like. An open loop gasket, for example but not meant to be limiting, may be installed in a part in a straight or linear fashion and/or the open loop gasket may be curved during installation to follow along a part shape or gasket groove and/or may extend around a corner of a part and the like. A “profile” of a gasket is used herein is a cross-sectional shape of the gasket. As noted below and with examples depicted in FIG. 8, a gasket's profile may have a variety of shapes. In some embodiments, the profile shape may change over the length of the gasket. Changes in profile shape over the length of the gasket may be due to changes in the sealing surfaces of the part that may require more or less gasket material to provide adequate sealing properties and/or change in profile to provide more or less sealing properties such as more or less pressure and the like at different points of the sealing surface.

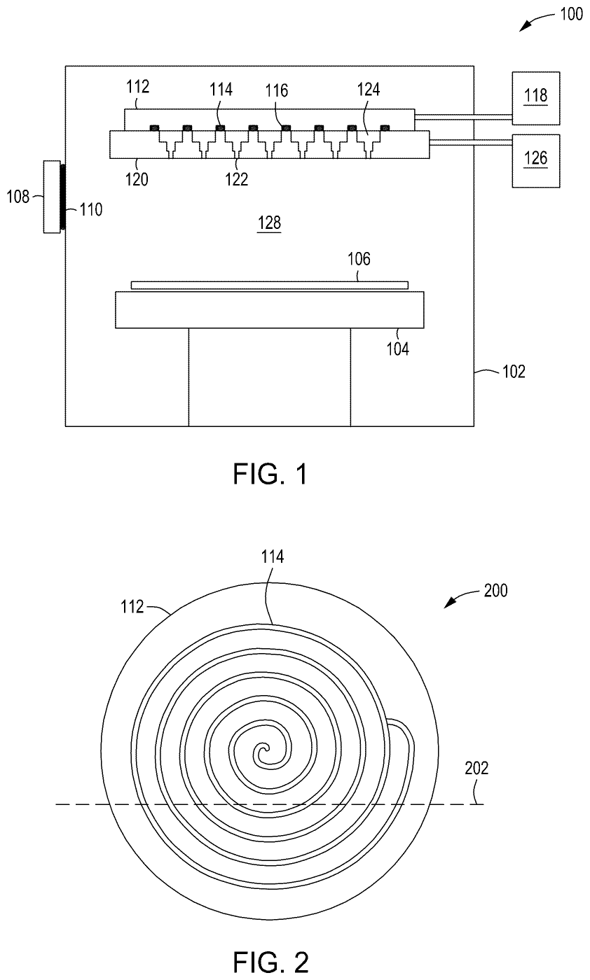

The methods of the present principles may be used in the formation of gaskets for any type of part used in the manufacturing of substrates. For example, but not meant to be limiting, in FIG. 1 is a process chamber 100 used in semiconductor substrate manufacturing. The process chamber 100 has walls 102 that enclose a substrate support 104 and a processing volume 128. The substrate support 104 is used to support a substrate 106 during processing. The process chamber 100 may be used in chemical vapor deposition (CVD) processes and includes a showerhead 120 and a cooling apparatus 112. The showerhead 120 includes gas channels 124 and gas nozzles 122 to distribute gas from a gas supply 126 into the processing volume 128. The cooling apparatus 112 includes a gasket 116 that is positioned within gasket groove 114 to keep the gas channels 124 of the showerhead 120 separated. The cooling apparatus 112 is connected to a cooling liquid supply 118. The inventors observed that the process chamber 100 had thermal and gas leak damage on the showerhead 120 after substrate processing. Upon further inspection, poor sealing of the gasket 116 was causing leakage between the gas channels 124. As depicted in bottom-up view 200 of FIG. 2, the cooling apparatus 112 has a gasket groove 114 that spirals from the center outward. The cross-sectional view of FIG. 1 is approximated by the dashed line 202 of FIG. 2. The gasket 116 is positioned within the gasket groove 114 by hand.

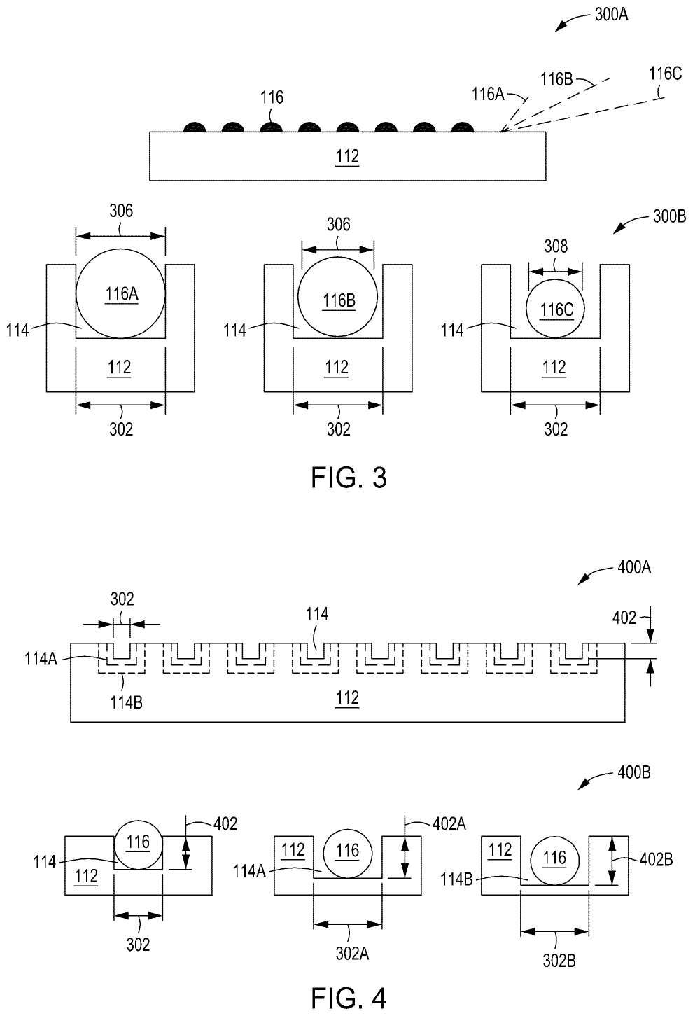

The inventors found that the installation of the gasket 116 by hand led to inconsistencies in the installation process. In a view 300A of FIG. 3, the inventors discovered that various amounts of “left over” gasket material occurred when different people installed the gasket 116 due to stretching of the gasket 116 during installation. For example, a first person had very little remaining gasket material after installing gasket 116A. As depicted in a view 300B of FIG. 3, the gasket 116A retained the original shape within the gasket groove 114 (gasket diameter 304 was approximately the same as the gasket groove width 302). A second person had stretched the gasket material somewhat during the installation of the gasket 116B. As depicted in the view 300B of FIG. 3, the gasket 116B has a smaller gasket diameter 306 than the gasket groove width 302. The gasket 116B may provide some amount of seal, but not as much as the gasket 116A. A third person had stretched the gasket material substantially during the installation of the gasket 116C. As depicted in the view 300B of FIG. 3, the gasket 116C has a much smaller gasket diameter 308 than the gasket groove width 302. The gasket 116C is no longer able to provide any sealing pressure at all and is substantially smaller than the dimensions (width or height) of the gasket groove 114. As manual installation of the gasket is standard practice, ensuring uniformity for the entire length of the gasket during installation is not possible.

Even with proper manual installation of the gasket 116, the inventors discovered another problematic issue occurs when a part is recycled. When a part, such as the cooling apparatus 112, is cleaned or etched during recycling, the gasket grooves become enlarged, leading to sealing failures. In a view 400A of FIG. 4, the cooling apparatus 112 is depicted with the gasket groove 114 having a height 402 and a width 302 as also depicted in a view 400B of FIG. 4. A dashed line in view 400A of FIG. 4 depicts a first cleaning cycle gasket groove 114A which is also depicted in a view 400B of FIG. 4. Both a height 402A and width 302A of the first cleaning cycle gasket groove 114A have been increased over the original height and width of gasket groove 114. The increased dimensions cause the gasket 116 to sit further into the groove providing less sealing pressure above and also the gasket 116 no longer makes immediate contact with the sides of the first cleaning cycle gasket groove 114A, allowing the gasket 116 to compress further before making sidewall contact. A dotted line in view 400A of FIG. 4 depicts a second cleaning cycle gasket groove 114B which is also depicted in a view 400B of FIG. 4. Both a height 402B and width 302B of the second cleaning cycle gasket groove 114B have been increased over the original height and width of gasket groove 114. The increased dimensions cause the gasket 116 to sit completely within the groove providing no sealing pressure above and also the gasket 116 no longer makes any contact with the sides of the second cleaning cycle gasket groove 114B, providing no sealing properties at all. Although the amounts of the etching of the gasket groove 114 have been exaggerated in FIG. 4 for illustration purposes, each recycling operation does reduce the sealing effectiveness of the gasket 116. In effect, the gasket 116 limits the number of recycling operations and, therefore, the working lifespan of the part.

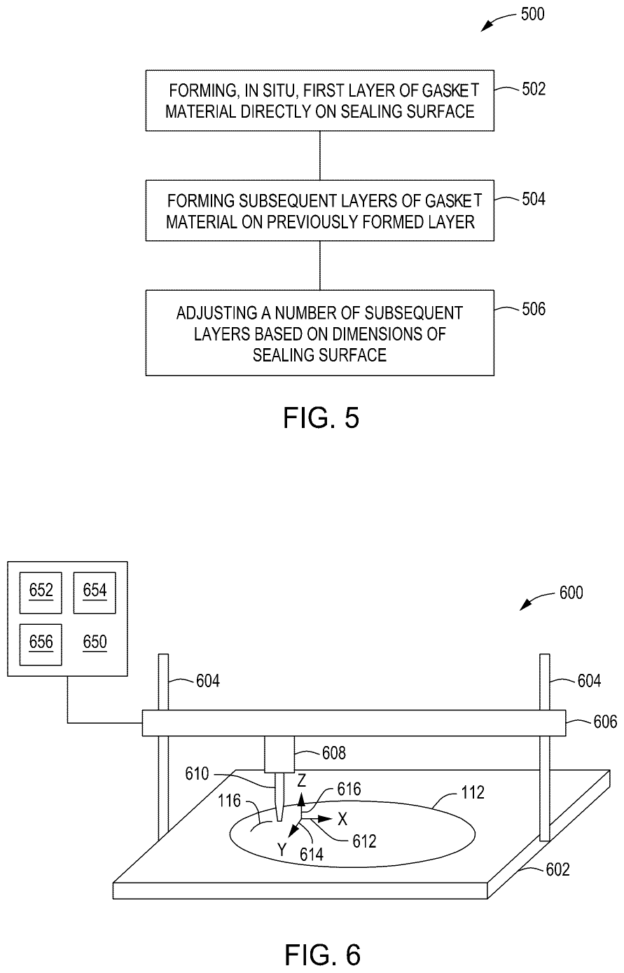

The inventors have discovered that if the gasket 116 can be formed in-situ on the part rather than manually installed by a person, the sealing properties of the gasket 116 can be maintained under the above-described circumstances and with additional benefits. FIG. 5 is a method 500 of forming a gasket in-situ on a part used for processing substrates. In block 502, a first layer of a gasket material is formed in-situ directly on a sealing surface of the part. The formation of the first layer may be performed by a contact or laminate printer using, for example but not limited to, thermoplastic materials as filament ink. In some embodiments, the gasket material may be an elastomer material to form an elastomer gasket. In some embodiments, the thermoplastic material may be a thermoplastic polyurethane, a thermoplastic elastomer, and/or a thermoplastic copolyester. For example, a contact printer 600 may be used to print the gasket 116 on the cooling apparatus 112 as depicted in FIG. 6. The contact printer 600 has a base 602 that holds the cooling apparatus 112 as a printer head 608 deposits gasket material through a nozzle 610 and moves back and forth in an X direction 612 on a printer head support 606. The printer head support 606 is held above the base 602 by supports 604. In some embodiments, the printer head 608 and nozzle 610 may also move back and forth in a Y direction 614 or the base 602 may move back and forth in a Y direction. By controlling the X and Y directions, the printer head 608 and nozzle 610 can create linear and non-linear gasket open loop shapes and/or closed loop shapes (e.g., curves, rectangles, circles, spirals, etc.). In an example depicted in FIG. 6, a non-linear printing example shows the printer head 608 and nozzle 610 printing the gasket 116 by following the inside of the entire spiral of the gasket groove 114 for each layer of the gasket 116. The printer head 608 and nozzle 610 also move in a Z direction 616 as each layer of filament is deposited to add height to the formation of the gasket 116.

An example of linear printing for a curved or spiral gasket groove is depicted in FIG. 13. The printer head 608 moves along dotted line 1304 in an X direction 1310 and deposits portions 1302 of a first layer in the gasket groove 114 of the cooling apparatus 112 as depicted in a top-down view 1300A and a cross-sectional view 1300B. The printer head 608 is then adjusted in the Y direction 1308 adjacent to the previous printing line in the X direction 1310 and repeats depositing portions of the first layer in the gasket groove 114 in the X direction 1310. The process is repeated until an entire first layer of the gasket is formed in the gasket groove 114. After completion of the first layer, subsequent layers of the gasket are formed by repeating the linear deposition process until the gasket is completed.

The contact printer 600 also includes a controller 650 that has a computer processing unit (CPU) 652, a memory 654, and supporting circuits 656. The controller 650 allows the contact printer to adjust the printing of a gasket based on dimensions of a sealing surface (3D sealing surfaces such as sides and bottom of the gasket groove 114 or planar sealing surfaces discussed below), number of cleaning cycles a part has undergone, and/or based on other properties such as nonuniformity of a part or nonuniformity of the gasket groove. The controller 650 can also be used to change the shape of the profile (discussed below) of a gasket during or prior to printing of the gasket, change or alter gasket materials during or prior to printing of the gasket, and/or change or alter the open loop shape or the closed loop shape of the gasket during or prior to printing of the gasket.

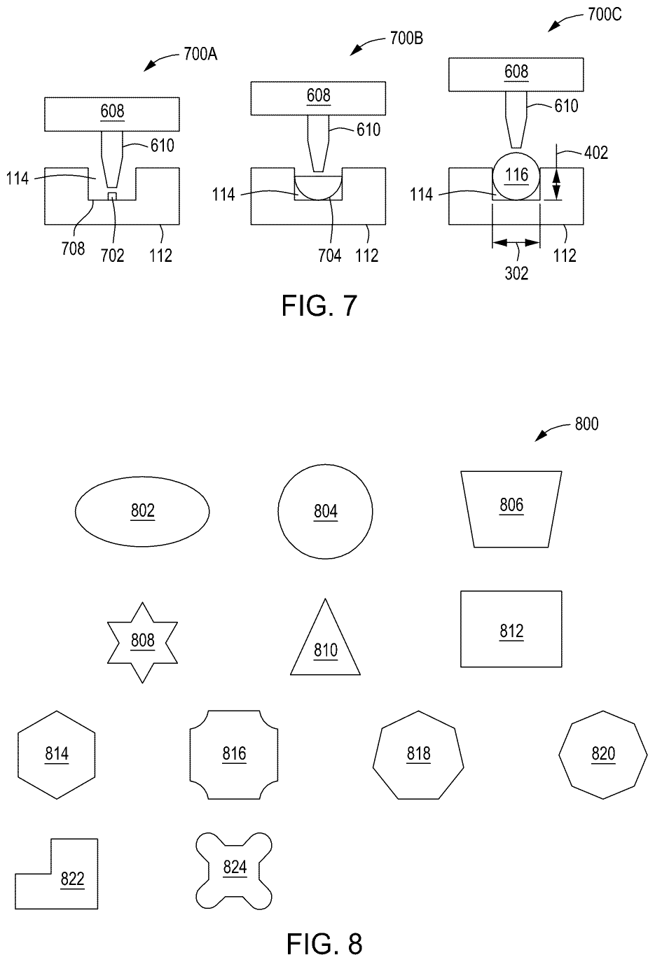

In view 700A of FIG. 7, the first layer 702 of the gasket material is depicted in the gasket groove 114 of the cooling apparatus 112. The first layer 702 adheres to the bottom surface 708 of the gasket groove 114. The adherence of the first layer 702 to the bottom surface 708 provides stability for the gasket material as subsequent layers are deposited and also keeps the gasket positioned correctly on the sealing surface (e.g., centers gasket in groove, keeps gasket from twisting in groove, keeps gasket from moving out of position on planar sealing surface, etc.). In block 504 of FIG. 5, subsequent layers of the gasket material are formed in-situ on a previously formed layer to form the gasket with a given profile shape. View 700B of FIG. 7 depicts partial formation 704 of the gasket in the gasket groove 114. In block 506, the number of subsequent layers is adjusted based on the dimensions of the sealing surface. Although a given profile shape may be preselected, the dimensions of the profile shape are adjusted to one or more dimensions of the sealing surface to account for irregularities or changes in dimensions due to cleaning, etc. The adjustment ensures proper fit of the gasket to the sealing surfaces. The adjustment may be accomplished prior to or during the formation of the gasket. In some embodiments, known or unknown deformities of a part or a gasket groove may be automatically accounted for during the gasket formation to ensure proper gasket sealing performance. In some embodiments, adjustments may be made to at least one cross-sectional dimension over a length of the gasket to compensate for dimensional changes of the sealing surface. View 700C of FIG. 7 depicts a completed formation of the gasket 116 in the gasket groove 114. The dimensions of the gasket 116 have been selected to provide sealing performance based on the gasket groove width 302 and height 402 of the gasket groove 114.

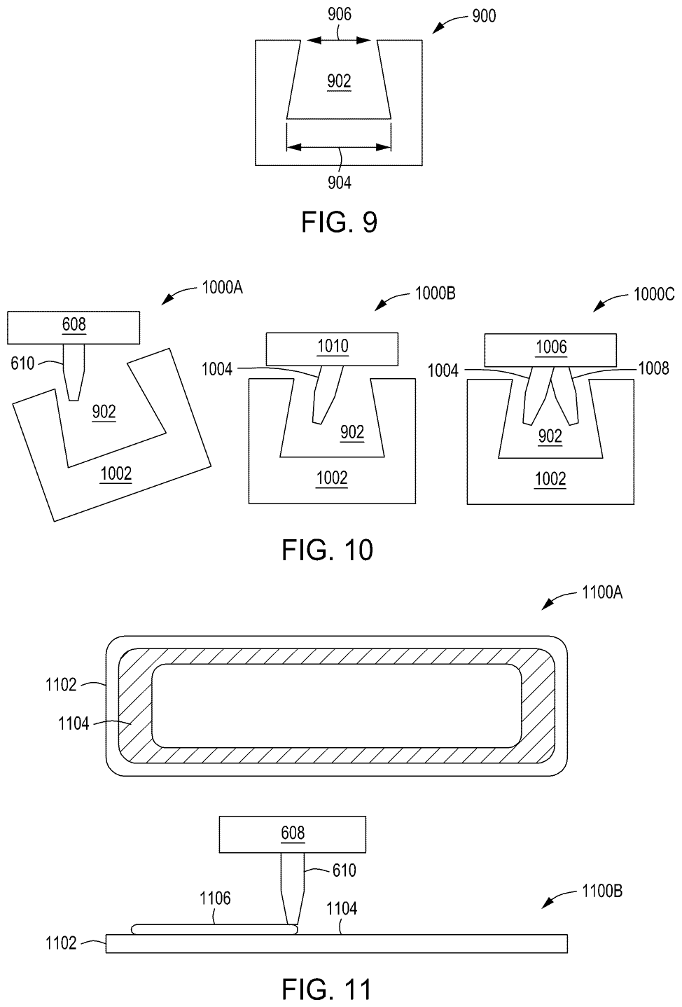

The view 800 of FIG. 8 depicts examples of, but are not limited to, gasket profile shapes that can be formed in-situ using the above method 500. The profile shapes include oval shapes 802, circular shapes 804, trapezoidal shapes 806, star shapes 808, triangular shapes 810, rectangular shapes 812, hexagonal shapes 814, polygonal shapes 816, heptagonal shapes 818, octagonal shapes 820, L-shapes 822, and/or cross pattern-based shapes 824, and the like. The method 500 can also be used to account for different gasket groove shapes such as the example depicted in view 900 of FIG. 9. The inventors have found that the groove shape of view 900 presents additional difficulties when using a contact printer. The groove shape of view 900 has an opening dimension 906 that is smaller than a bottom dimension 904 of the gasket groove 902. The nozzle 610 of the contact printer 600 needs to be able to reach areas of the gasket groove that require gasket materials to be formed. The nozzle 610 of the contact printer 600 is perpendicular to the sealing surface and cannot reach undercut areas of the gasket groove 902 for example.

To enable contact printers to print into under cut areas of the gasket groove, the inventors found that the base 602 of contact printer 600 can be modified to tilt a part 1002 as depicted in view 1000A of FIG. 10. In some embodiments, rather than tilt the base 602 of the contact printer 600, a printer head 1010 can be modified to include an angled nozzle 1004 as depicted in view 1000B of FIG. 10. The angled nozzle 1004 may be fixed at a given angle or may be adjustable to allow printing while the angled nozzle 1004 is angled to the left or angled to the right. In some embodiments, the angling of the angled nozzle 1004 may be automated to allow the contact printer to reach all areas of the sealing surfaces. In some embodiments, a printer head 1006 may be modified with two or more angled nozzles 1004, 1008 to allow simultaneously printing (for faster printing speeds, etc.) or single nozzle printing without requiring nozzle adjustments for each side of an undercut in a sealing surface.

As discussed previously, the sealing surface may include inner surfaces of a gasket groove (e.g., sides, bottom, etc.) and/or planar surfaces. In a view 1100A, an example of a part with a planar sealing surface is depicted. In the example, the part is a valve slit door 1102 similar to the valve slit door 108 with gasket 110 of the process chamber 100 depicted in FIG. 1. The valve slit door 1102 has a planar sealing surface 1104. In a view 1100B, a contact printer 600 with printer head 608 and nozzle 610 is in the process of printing a gasket 1106 in-situ on the planar sealing surface 1104. The gasket profile shape, width, height, gasket material, and length can be adjusted prior to or during printing of the gasket 1106. Because the initial layer is adhered to the sealing surface, the gasket remains in the correct position during and/or after installation.

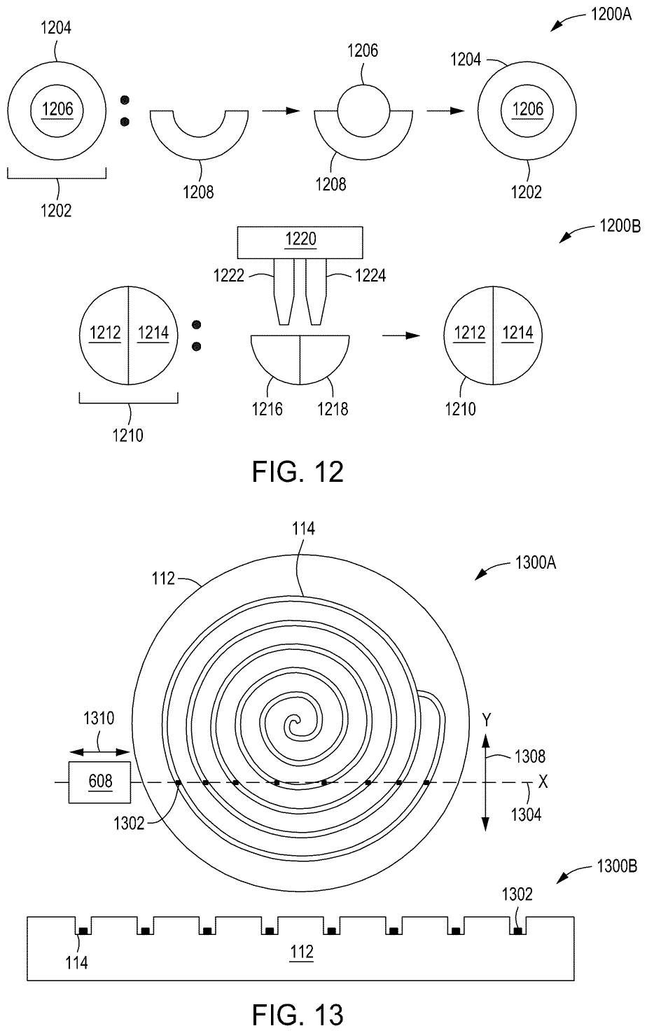

In some embodiments, modification of the gasket material properties is desirable. For some cases, a gasket may require a stiffer or harder core and a softer more flexible outer surface to retain the shape of the gasket while providing higher sealing capabilities with the softer outer material. In some embodiments, the opposite construction may be desirable (e.g., soft inner core and more resilient outer surface or a more chemical resistant outer surface, etc.). For example, in view 1200A of FIG. 12, a hard-core gasket 1202 is formed in-situ by using a softer or more flexible gasket material as the outer material which is deposited as a first portion 1208. The second portion 1206 is the hard-core material and is formed on the first portion 1208. A third portion 1204 of the softer more flexible material is then deposited to complete the hard-core gasket 1202. In some embodiments, the core may be formed of a metallic material and the outer material may be a non-metallic material. In some embodiments, having a mixed, multi-property gasket 1210 may be desirable as depicted in a view 1200B of FIG. 12. The multi-property gasket 1210 has a first half formed of a first gasket material 1212 and second gasket material 1214 formed of a second material. The percentage of first gasket material 1212 and the second gasket material 1214 is not required to be 50/50 and can be any ratio. In addition, the orientation of the first gasket material 1212 and the second gasket material 1214 does not have to be side-by-side and can be one on top of the other and/or at various angles relative to a bottom surface of the sealing surface. In some embodiments, the gasket material can be altered layer-by-layer and the like. In the example of view 1200B, a modified dual nozzle 1222, 1224 and printer head 1220 are used to simultaneously print both halves (a first portion of a first material 1216 and a first portion of a second material 1218 is shown during a printing process) of the multi-property gasket 1210 for speed and efficiency. However, each half can also be printed separately with a single nozzle printer head. In some embodiments, the properties of different gasket materials may require that the materials be heated after formation of the gasket to allow for better fusing of the materials and/or to alter the properties of the gasket material. The heating may also be required for single gasket materials as well to alter the properties to more desirable properties by heating to enhance the sealing properties.

Material selection of the gasket material may be based on a Shore hardness scale. In some embodiments, the Shore hardness scale value may range from 70 A to 95 A depending on where and/or how the gasket is to be used. In some embodiments, multiple types of gasket material may be used with different Shore hardness scale values. The material may also be selected based on temperature range and/or resistance to chemicals and the like.

Embodiments in accordance with the present principles may be implemented in hardware, firmware, software, or any combination thereof. Embodiments may also be implemented as instructions stored using one or more computer readable media, which may be read and executed by one or more processors. A computer readable medium may include any mechanism for storing or transmitting information in a form readable by a machine (e.g., a computing platform or a “virtual machine” running on one or more computing platforms). For example, a computer readable medium may include any suitable form of volatile or non-volatile memory. In some embodiments, the computer readable media may include a non-transitory computer readable medium.

While the foregoing is directed to embodiments of the present principles, other and further embodiments of the principles may be devised without departing from the basic scope thereof.

1. A method of creating a gasket, comprising:
obtaining a part used for substrate processing, the part having a sealing surface for interfacing with an elastomer gasket; and
forming the elastomer gasket layer-by-layer on the sealing surface.

2. The method of claim 1, further comprising:
cleaning the part prior to forming the elastomer gasket on the sealing surface; and
adjusting a dimension of the elastomer gasket to compensate for changes to the sealing surface caused by cleaning the part.

3. The method of claim 2, further comprising:
adjusting the dimension of the elastomer gasket based on a number of cleaning cycles undergone by the part.

4. The method of claim 1, wherein the sealing surface is a gasket groove or a planar surface.

5. The method of claim 4, wherein the gasket groove has a bottom width and an opening width of approximately similar dimensions or a bottom width of greater dimensions than an opening width.

6. The method of claim 1, further comprising:
forming the elastomer gasket with a cross-section profile of a star, a circle, a rectangle, a circle, a polygon, or a triangle.

7. The method of claim 1, further comprising:
forming the elastomer gasket using multiple types of gasket materials.

8. The method of claim 7, wherein the multiple types of gasket materials have different Shore hardness scale values.

9. The method of claim 1, further comprising:
forming a core of the elastomer gasket of a metallic material and outer portions of the elastomer gasket of a non-metallic material.

10. The method of claim 1, further comprising:
heating the elastomer gasket after formation of the elastomer gasket is completed.

11. The method of claim 1, further comprising:
forming the elastomer gasket using a thermoplastic polyurethane material, a thermoplastic elastomer material, or a thermoplastic copolyester material.

12. The method of claim 1, further comprising:
forming the elastomer gasket using a contact printer with an angled printing nozzle of less than 90 degrees.

13. The method of claim 1, further comprising:
forming the elastomer gasket using two or more gasket materials deposited using a contact printer with two or more printing nozzles for simultaneous deposition of the two or more gasket materials.

14. The method of claim 1, further comprising:
forming the elastomer gasket using a contact printer; and
tilting a base of the contact printer during formation of the elastomer gasket in a recessed area of a gasket groove in the part.

15. The method of claim 1, further comprising:
adjusting at least one cross-sectional dimension over a length of the elastomer gasket to compensate for dimensional changes of the sealing surface.

16. A method of creating a gasket, comprising:
obtaining a part used for substrate processing, the part having a gasket groove for interfacing with an elastomer gasket;
cleaning the part;
adjusting a dimension of the elastomer gasket to compensate for changes to the gasket groove caused by cleaning the part; and
forming the elastomer gasket layer-by-layer in the gasket groove.

17. The method of claim 16, further comprising:
adjusting the dimension of the elastomer gasket based on a number of cleaning cycles undergone by the part.

18. The method of claim 16, further comprising:
forming the elastomer gasket using multiple types of gasket materials; or
adjusting at least one cross-sectional dimension over a length of the elastomer gasket to compensate for dimensional changes of the gasket groove.

19. A non-transitory, computer readable medium having instructions stored thereon that, when executed, cause a method for creating an elastomer gasket to be performed, the method comprising:
obtaining a part used for substrate processing, the part having a sealing surface for interfacing with an elastomer gasket; and
forming the elastomer gasket layer-by-layer on the sealing surface.

20. The method of the non-transitory, computer readable medium of claim 19, further including a, b, c, d, e, or f:
(a) wherein the sealing surface is a gasket groove with a bottom width of greater dimensions than an opening width;
(b) forming the elastomer gasket with a cross-section profile of a star, a circle, a square, a circle, or a triangle;
(c) forming the elastomer gasket using multiple types of gasket materials and the multiple types of gasket materials have different Shore hardness scale values;
(d) forming a core of the elastomer gasket of a metallic material and outer portions of the elastomer gasket of a non-metallic material;
(e) adjusting a size of the elastomer gasket formed based on a number of cleaning cycles undergone by the part; or
(f) adjusting at least one cross-section dimension over a length of the elastomer gasket to compensate for dimensional changes of the sealing surface.
